(19) United States
(12) Patent Application Publication
(10) Pub. No.: US 2018/0314805 A1
(43) Pub. Date: Nov. 1, 2018

(54) CONSTRAINT-AWARE HEALTH MANAGEMENT

(71) Applicant: INTERNATIONAL BUSINESS MACHINES CORPORATION, Armonk, NY (US)

(72) Inventors: Hung-Yang Chang, Scarsdale, NY (US); Ching-Hua Chen, YORKTOWN HEIGHTS, NY (US); Zhiguo Li, Yorktown Heights, NY (US); Kun Lin, Bethesda, MD (US)

(21) Appl. No.: 15/497,802

(22) Filed: Apr. 26, 2017

(51) Int. Cl. G06F 19/00

(52) U.S. Cl. CPC G06F 19/3481; G06F 19/3418

(57) ABSTRACT

Embodiments of technical solutions are described for a health management system that facilitates adaptively tracking a health-management goal. An example computer-implemented method includes receiving a cumulative target for a predetermined duration for a user, and generating a target activity time-series for the predetermined duration to meet the cumulative target. The method further includes receiving a user-activity time-series for the user that indicates activity performed by the user to meet the cumulative target and monitoring a difference between the target activity time-series and the user-activity time-series. The method further includes determining, based on the difference, a probability value that indicates the user missing the cumulative target, and generating an updated target activity time-series for the user in response to the probability value being above a predetermined threshold.

### BACKGROUND

The present application relates to computing technology, and more specifically, to using electronic circuits to facilitate constraint-aware health management.

Many people are affected by a variety of health problems such as obesity, diabetes, high blood pressure, high cholesterol etc., which typically are linked to poor health habits, such as diet, exercise, and the like. Even if people are aware that controlling diet, exercise, and other lifestyle habits are critical for being healthy, adopting and maintaining such habits seems to be a challenge.

There are various electronic devices and systems, such as wearable devices, phones, software-applications, and so on, for assisting individuals with the maintenance of healthy lifestyle habits. Typically, such systems use a diet and exercise regimes, which can be standard, or customized for an individual's current health status.

### SUMMARY

According to one or more embodiments of the invention, a computer implemented method for adaptively tracking a health-management goal includes receiving, by a processor, a cumulative target for a predetermined duration for a user. The method further includes generating, by the processor, a target activity time-series for the predetermined duration to meet the cumulative target. The method further includes receiving, by the processor, a user-activity time-series for the user that indicates activity performed by the user to meet the cumulative target. The method further includes monitoring, by the processor, a difference between the target activity time-series and the user-activity time-series. The method further includes determining, by the processor, based on the difference, a probability value that indicates the user missing the cumulative target. The method further includes generating, by the processor, an updated target activity time-series for the user in response to the probability value being above a predetermined threshold.

According to one or more embodiments of the invention, a health management system includes a memory, and a processor coupled with the memory. The processor receives a cumulative target for a predetermined duration for a user. The processor further generates a target activity time-series for the predetermined duration to meet the cumulative target. The processor further generates receive a user-activity time-series for the user that indicates activity performed by the user to meet the cumulative target. The processor further monitors a difference between the target activity time-series and the user-activity time-series. The processor further determines based on the difference, a probability value that indicates the user missing the cumulative target. The processor further generates an updated target activity time-series for the user in response to the probability value being above a predetermined threshold.

According to one or more embodiments of the invention, a computer program product for a health goal management includes a computer readable storage medium having program instructions embodied therewith. The program instructions executable by a processing circuit to cause the processing circuit to receive a cumulative target for a predetermined duration for a user. The program instructions further cause the processing circuit to generate a target activity time-series for the predetermined duration to meet the cumulative target. The program instructions further cause the processing circuit to generate receive a user-activity time-series for the user that indicates activity performed by the user to meet the cumulative target. The program instructions further cause the processing circuit to monitor a difference between the target activity time-series and the user-activity time-series. The program instructions further cause the processing circuit to determine based on the difference, a probability value that indicates the user missing the cumulative target. The program instructions further cause the processing circuit to generate an updated target activity time-series for the user in response to the probability value being above a predetermined threshold.

### BRIEF DESCRIPTION OF THE DRAWINGS

The examples described throughout the present document will be better understood with reference to the following drawings and description. The components in the figures are not necessarily to scale. Moreover, in the figures, like-referenced numerals designate corresponding parts throughout the different views.

FIG. 1 depicts a cloud computing environment according to an embodiment of the present invention.

FIG. 2 depicts abstraction model layers according to an embodiment of the present invention.

FIG. 3 shows an example physical structure of a health management system, according to one or more embodiments of the invention.

FIG. 4 illustrates an example apparatus, according to one or more embodiments of the invention.

FIG. 5 illustrates one or more components of a health management system, according to one or more embodiments of the invention.

FIG. 6 illustrates a flow-chart of an example method for dynamically tracking and adapting activity targets for a user, according to one or more embodiments of the invention.

FIG. 7 illustrates an example scenario, according to one or more embodiments of the invention.

FIG. 8 illustrates a flow chart of an example method for generating a predictive model for predicting a probability of the user meeting a timeslot goal, according to one or more embodiments of the invention.

FIG. 9 illustrates a flow chart of an example method for determining a probability of the user missing an activity target, according to one or more embodiments of the invention.

FIG. 10 illustrates example scenarios implemented by a health management system according to one or more embodiments of the invention.

### DETAILED DESCRIPTION

Described here are technical solutions for facilitating a constraint-aware method for adaptively tracking and re-planning a cumulative target metric with finite deadline. For example, the technical solutions facilitate dynamic goal setting for a user under user-specific constraints. The goal setting includes adjusting a health-management goal for the user taking the user-constraints into account, such as a number of steps, a number of calories to expend, a number of calories to intake, and so on. The technical solutions thus provide improvements to health-management systems that facilitate the user to set the health-management goals, by dynamically adjusting the goals by taking the user constraints into consideration. As such, the technical solutions are rooted in and/or tied to computer technology in order to overcome a problem specifically arising in the realm of computers, specifically health-management systems.

It is understood in advance that although this disclosure includes a detailed description on cloud computing, implementation of the teachings recited herein are not limited to a cloud computing environment. Rather, embodiments of the invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

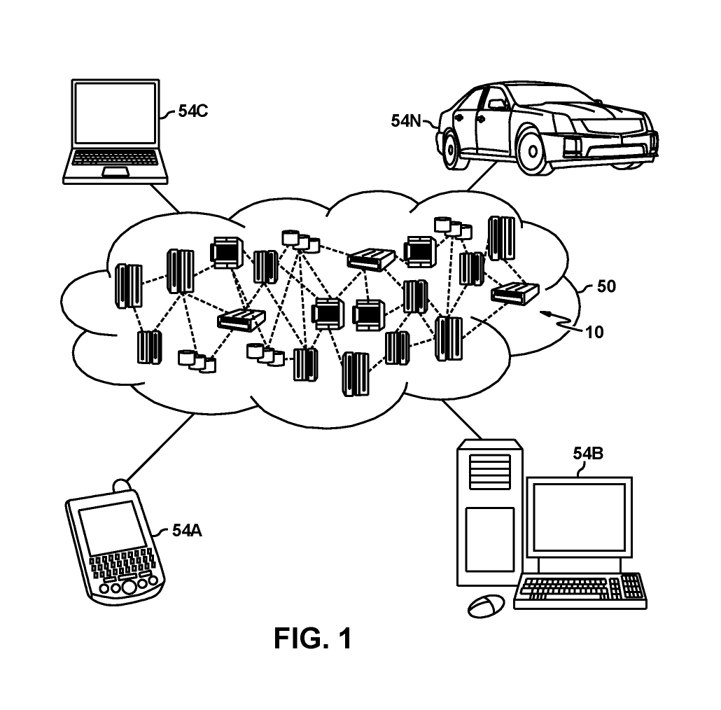

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

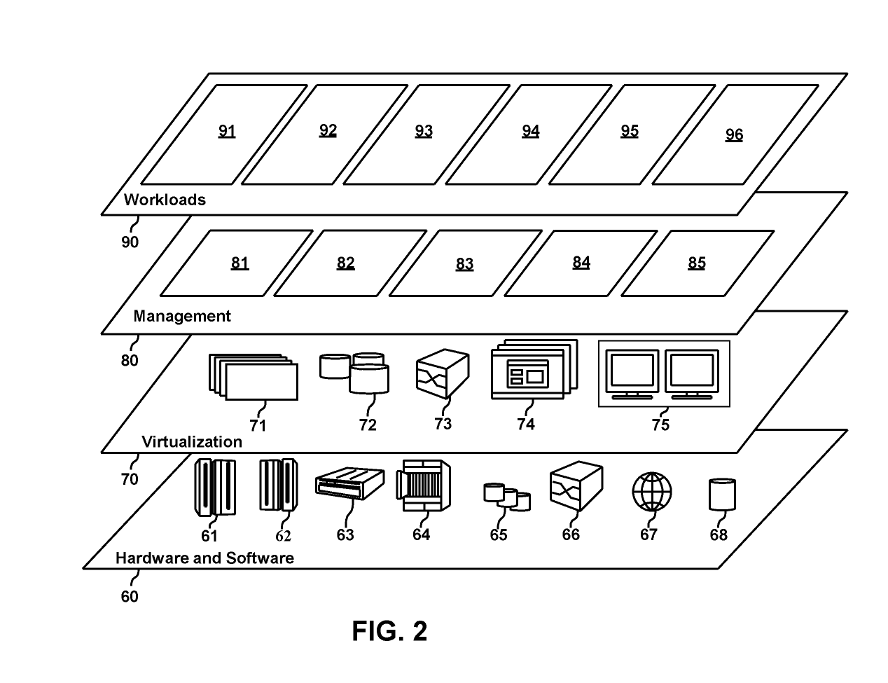

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments of the invention, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and health management 96.

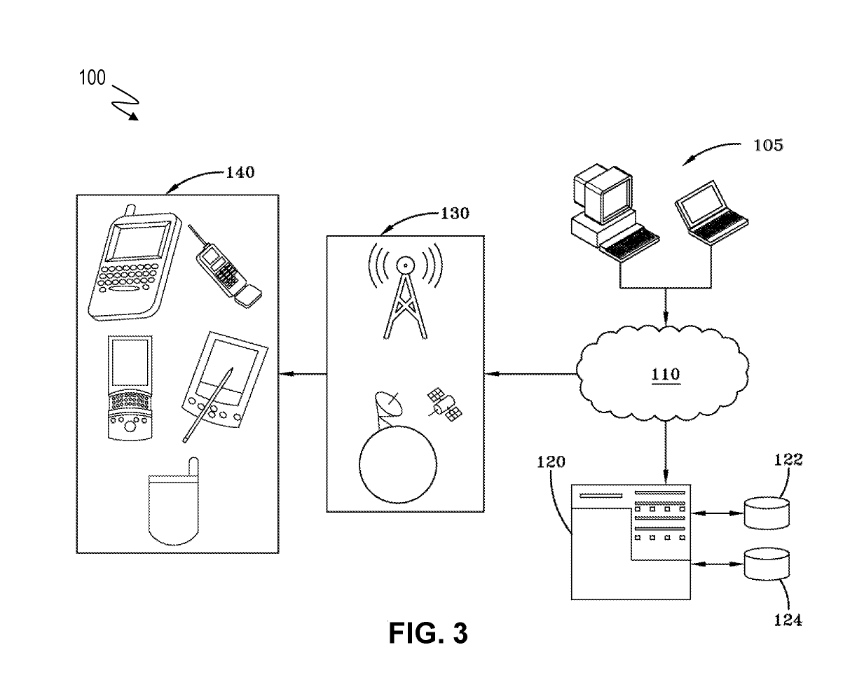

FIG. 3 shows an example physical structure of a health management system 100 according to one or more embodiments of the invention. Each of the connections mentioned here permit data to flow in both directions. A communication device 105 is connected to a server 120 through the internet 110. The communication device 105 can be laptop or desktop personal computer, a tablet computer, a phone, or any other electronic device that can communicate via the network 110. The user may connect to the health management system 100 to create an account and enter personal information and preferences for creating a profile.

The server 120 is connected to one or more databases 122, 124 comprising user data, nutrition provider data (nutritional data related to meals offered by a plurality of meal providers), diet, and exercise data, message data, progress data, compliance data, restaurant, shopping, and entertainment establishment data, reward data, and other data that can provide the features and functionality of the health management system 100. The server 120 is connected to communication networks 130 (comprising various data transmitters and receivers) through the internet 110.

The various data transmitters and receivers of the communication networks 130 facilitate communications with the user's multiple portable electronic devices 140, which include cellular or mobile phones, personal digital assistants, wearable devices, or any other portable device capable of sending and receiving communications through the communication networks 130 and displaying them for the user.

The health management system can include a component that executes at the server 120 that uses the individual's account information, including information about the individual's mobile phone, to tailor and send to the individual messages, such as messages to reinforce and motivate healthy habits, and dynamically adjusted goals. It should be noted, that although the examples herein describe the health management system 100 including the server 120 to dynamically adjust user goals, in one or more examples, one of the user's device 105 and/or 140 can adjust the goal dynamically by implementing one or more technical solutions described herein.

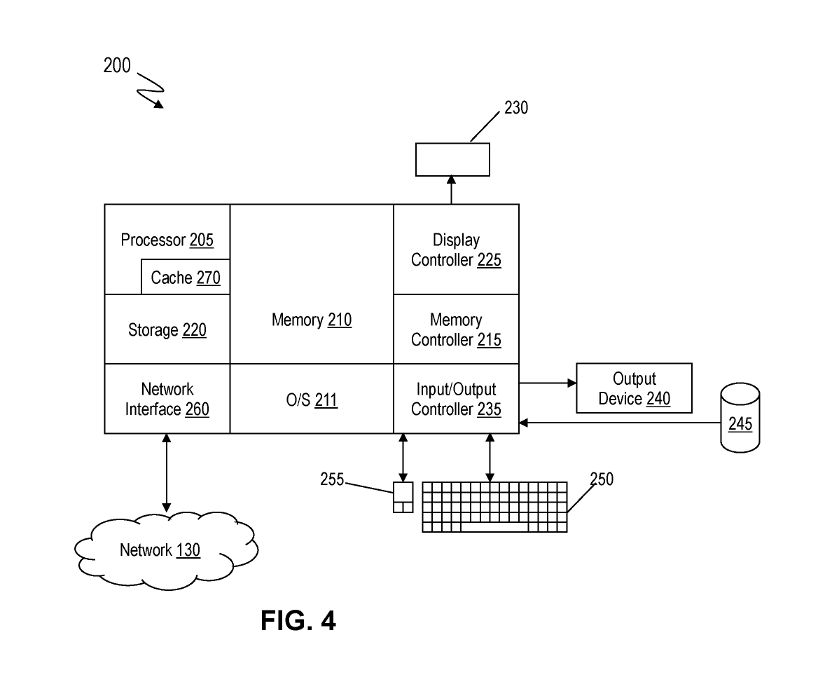

FIG. 4 illustrates an example apparatus 200, according to one or more embodiments of the invention. The apparatus 200 may be a communication apparatus, such as a computer. For example, the apparatus 200 may be a desktop computer, a tablet computer, a laptop computer, a phone, such as a smartphone, a server computer, or any other device that communicates via the communication network 130. The apparatus 300 includes hardware, such as electronic circuitry, and can be used as any one of the devices illustrated in FIG. 3.

The apparatus 200 includes, among other components, a processor 205, memory 210 coupled to a memory controller 215, and one or more input devices 245 and/or output devices 240, such as peripheral or control devices, that are communicatively coupled via a local I/O controller 235. These devices 240 and 245 may include, for example, battery sensors, position sensors (altimeter, accelerometer, GPS), indicator/identification lights and the like. Input devices such as a conventional keyboard 250 and mouse 255 may be coupled to the I/O controller 235. The I/O controller 235 may be, for example, one or more buses or other wired or wireless connections, as are known in the art. The I/O controller 235 may have additional elements, which are omitted for simplicity, such as controllers, buffers (caches), drivers, repeaters, and receivers, to enable communications.

The I/O devices 240, 245 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 205 is a hardware device for executing hardware instructions or software, particularly those stored in memory 210. The processor 205 may be a custom made or commercially available processor, a central processing unit (CPU), an auxiliary processor among several processors associated with the system 100, a semiconductor based microprocessor (in the form of a microchip or chip set), a macroprocessor, or other device for executing instructions. The processor 205 includes a cache 270, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 may be organized as a hierarchy of more cache levels (L1, L2, and so on.).

The memory 210 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 may incorporate electronic, magnetic, optical, or other types of storage media. Note that the memory 210 may have a distributed architecture, where various components are situated remote from one another but may be accessed by the processor 205.

The instructions in memory 210 may include one or more separate programs, each of which comprises an ordered listing of executable instructions for implementing logical functions. In the example of FIG. 4, the instructions in the memory 210 include a suitable operating system (OS) 211. The operating system 211 essentially may control the execution of other computer programs and provides scheduling, input-output control, file and data management, memory management, and communication control and related services.

Additional data, including, for example, instructions for the processor 205 or other retrievable information, may be stored in storage 220, which may be a storage device such as a hard disk drive or solid state drive. The stored instructions in memory 210 or in storage 220 may include those enabling the processor to execute one or more aspects of the systems and methods described herein.

The apparatus 200 may further include a display controller 225 coupled to a user interface or display 230. In some embodiments of the invention, the display 230 may be an LCD screen. In other embodiments of the invention, the display 230 may include a plurality of LED status lights. In some embodiments of the invention, the apparatus 200 may further include a network interface 260 for coupling to a network 265. The network 265 may be an IP-based network for communication between the apparatus 200 and an external server, client and the like via a broadband connection. In an embodiment, the network 265 may be a satellite network. The network 265 transmits and receives data between the apparatus 200 and external systems. In some embodiments of the invention, the network 265 may be a managed IP network administered by a service provider. The network 265 may be implemented in a wireless fashion, for example, using wireless protocols and technologies, such as WiFi, WiMax, satellite, or any other. The network 265 may also be a packet-switched network such as a local area network, wide area network, metropolitan area network, the Internet, or other similar type of network environment. The network 265 may be a fixed wireless network, a wireless local area network (LAN), a wireless wide area network (WAN) a personal area network (PAN), a virtual private network (VPN), intranet or other suitable network system and may include equipment for receiving and transmitting signals.

The health management system 100 (shown in FIG. 3) facilitates the user maintaining activity adherence. For example, in fitness management a user giving up on goals is a typical reason for the fitness regimen to fail. For example, users often do not adhere to the recommended, or set goals because the goals do not factor in their constraints (e.g., meetings, geography, weather, physical ability). Thus, such goals that do not adaptively factor in the user constraint lose user engagement and become ineffective. The health management system 100 facilitates adjusting the user's daily activity plan based on his/her constraints, and thus facilitates improving the user's chances of meeting a set and/or recommended health-management goal.

For example, if the user has a meeting at 1:00 pm, the health management system 100 automatically identifies such a meeting as a constraint. Alternatively, or in addition, the health management system 100 identifies constraints provided by the user. Based on the constraints, the health management system 100 adjusts the user's health-management goal such that an activity associated with the health-management goal is not scheduled in proximity with the constraints.

Further, based on historical data, the health management system 100 determines the user's preferences, such as the user's preference to exercise at 7:00 pm. The health management system 100, accordingly, adjusts the user's health-management goal based on such preferences.

Alternatively, or in addition, the health management system 100 facilitates notifying the user during periods that are historically observed to be related to missing the user's health-management goal. Accordingly, the health management system 100 sends a message to the user to initiate an activity to meet a user-set or a dynamically adjusted goal.

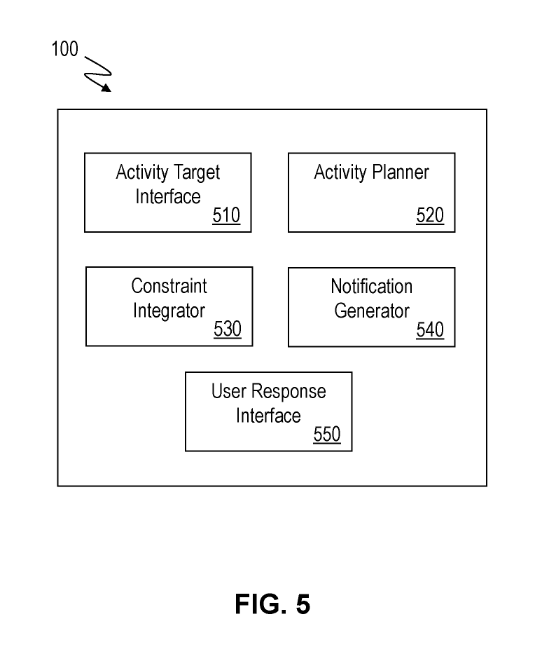

FIG. 5 illustrates one or more components of the health management system 100, according to one or more embodiments of the invention. It should be noted that the illustrated components are just one example, and that in other examples, the health management system 100 can include fewer, additional, or different components to implement the technical solutions described herein. Further, one or more of the components can be an electronic circuit, such as an application specific integrated circuit (ASIC), a field programmable gate array (FPGA), or any other circuit. Alternatively, or in addition, the components can be software modules that include one or more computer executable instructions stored on a memory device. Further yet, it should be noted that the components illustrated in FIG. 5 can be implemented by any one or more of the devices illustrated in FIG. 3.

The health management system 100, illustrated in FIG. 5, includes an activity target interface 510, an activity planner 520, a constraint integrator 530, a notification integrator 540, and a user response interface 550, among other components. The health management system 100 creates a mathematical model, such as a linear quadratic model, for the user's activity based on the user's specified goal, constraints, and user's responses to one or more messages from the health management system 100.

In one or more examples, the user provides the health management system 100 a username, password, and email address to create the profile. The user may further provide contact information, such as a mobile phone or other portable device information so that messages from the health management system 100 can be forwarded to the user's device.

In one or more examples, the activity target interface 510 facilitates the user to specify the user's profile that includes, for example, physical characteristics. For example, the user specifies a sex, age, weight, and height and a goal weight. This information is saved in the user's profile and is used to determine the user's progress toward a goal. The health management system 100 generates tailored messages that help the user to know and stay motivated to make progress toward the goal.

Further, in one or more examples, the activity planner 520 generates a health-management goal for the user based on the user's profile using comparable profiles, and/or recommended health-management goals for such a profile. Alternatively, or in addition, the activity target interface 510 receives a health-management goal from the user, which the activity planner 520 uses. In one or more examples, the goal is a numeric, quantifiable goal, such as a number of steps to take, number of net-calories, and so on. Further, in one or more examples, the goal is for a predetermined duration, such as a day, a week, an hour, and so on. For example, a goal that the user can enter via the activity target interface 510 can indicate 5000 steps in a day. Alternatively, or in addition, the user can enter a goal stating net-calories (calories expended−calorie intake) of 2000. It should be noted that the above are examples and that in other examples, the user may specify different goals than those listed here.

In one or more examples, the health management system 100 uses the goal stated to generate a target activity time-series for the predetermined duration. The activity planner 520 divides the predetermined duration (e.g.: day) for the goal into one or more timeslots. The activity planner 520 further divides the goal into a set of one or more activities, referred to as the activity time-series, each activity to be performed during the one or more timeslots respectively.

For example, for the goal of 5000 steps a day, the health management system 100 generates a time series such as a 210 steps per hour of the day. However, the health management system 100, as described further, takes into consideration, one or more constraints for the user's schedule over the predetermined duration for the goal and alters the time-series accordingly. Further yet, the activity target interface 510 displays the time-series to the user. The activity target interface 510 further facilitates the user to adjust the time-series.

The constraint integrator 530 facilitates integrating user's constraints for the activity planner 520 to generate and dynamically adjust the time-series for the user. In one or more examples, the constraint integrator 530 determines a penalty value for each of the timeslots in the time-series based on the constraints for that timeslot. A high penalty value indicates that the user has higher probability of not completing an activity assigned to that timeslot. Conversely, a lower penalty value indicates a higher probability of completion of the activity. The penalty value can thus be a function of the probability of completion of the activity. For example, the penalty value can be inversely proportional to the probability of completion.

The constraint integrator 530 assigns the penalty value based on the type of constraint. For example, the constraints include meetings, exercise class, meal times, meal restrictions, and so on. The constraint aggregator 530 takes information from various sources and translates the information into the penalty function (e.g., high penalty values for periods of unavailability).

In one or more examples, the constraint integrator 530 determines time constraints for the user by accessing one or more calendars for the user that indicate the user's schedule, such as meetings, appointments, or other time commitments. The constraint integrator 530 determines the availability/unavailability of the user for the activity accordingly. Alternatively, or in addition, the constraint integrator 530 keeps track of the user's daily activities to determine activities that the user typically engages in during specific times of the day. For example, the constraint integrator 530 identifies that the user typically takes a higher amount of steps between 7 AM and 8 AM compared to 8 AM and 9 AM. Accordingly, the constraint integrator 530 assigns a lower penalty function value to the 7 AM-8 AM timeslot than the 8 AM-9 AM timeslot.

In one or more examples, the constraint integrator 530 further takes into consideration past success/failure of meeting goals to adjust the penalty function. For example, if the user has met (or not met) activity goals set for a specific timeslot for at least a predetermined percentage of time, (e.g.: 70%, 80%), the constraint integrator 530 adjusts the penalty value for the timeslot accordingly.

The constraint integrator 530 further takes into consideration dietary restrictions to determine penalty values for calorie intake related goals for a timeslot. For example, the user specifies to the health management system 100 foods that he or she does not like or wants to avoid; for example, meats, poultry, and fish, beans, nuts, seeds, grains and soy products, fruit, vegetables, dairy, condiments and dressings. In one or more examples, the user can select from the foods from a list provided via the user-interface of the health management system 100. Foods identified are not included in meal suggestions that are provided to the user.

The activity planner 520 further uses the penalty function values determined by the constraint integrator 530 to adaptively adjust the activity target time-series according to the updated constraints. For example, the activity planner 520 uses a linear quadratic regulator to adjust the activities for the time-series.

The notification generator 540 generates one or more notifications for the user. For example, if the activity planner 520 adjusts the target activity time-series based on the predictive model, the notification generator 540 generates and triggers a notification to the user. In one or more examples, the notification generator 540 can also interact with people in the user's social network. For example, the notification generator 540 notifies one or more persons from the user's social network of the activity time-series, for example to help motivate the user. Alternatively, or in addition, the notification generator 540 can auto schedule the adjusted activity time-series in user's calendar.

Thus, the health management system 100 sets or receives a goal for the user. The health management system 100 generates an activity time-series for the user based on the goal and the user's constraints that may be determined based on the user's calendar, the user's input, or any other sources. Further, the health management system 100 generates and uses a predictive model to periodically determine a probability of the user meeting a goal according to the time-series and in turn, the cumulative goal that was divided into the time-series. Based on the probability, the health management system 100 adaptively updates the time-series, and sends a notification to the user of the change.

The health management system 100 further includes the user response interface 550, which receives the user's response to the notification sent by the notification generator 540. For example, the user can respond to the updated time-series in a positive manner, for example by taking one or more actions for meeting the updated activity time-series. Alternatively, or in addition, the user may respond to the updated time-series indicating that s/he cannot be able to take one or more actions to meet the updated time-series. Based on the user's response, the constraint integrator 530 further updates the time-series. Alternatively, or in addition, the constraint integrator 530 updates the cumulative goal of the user.

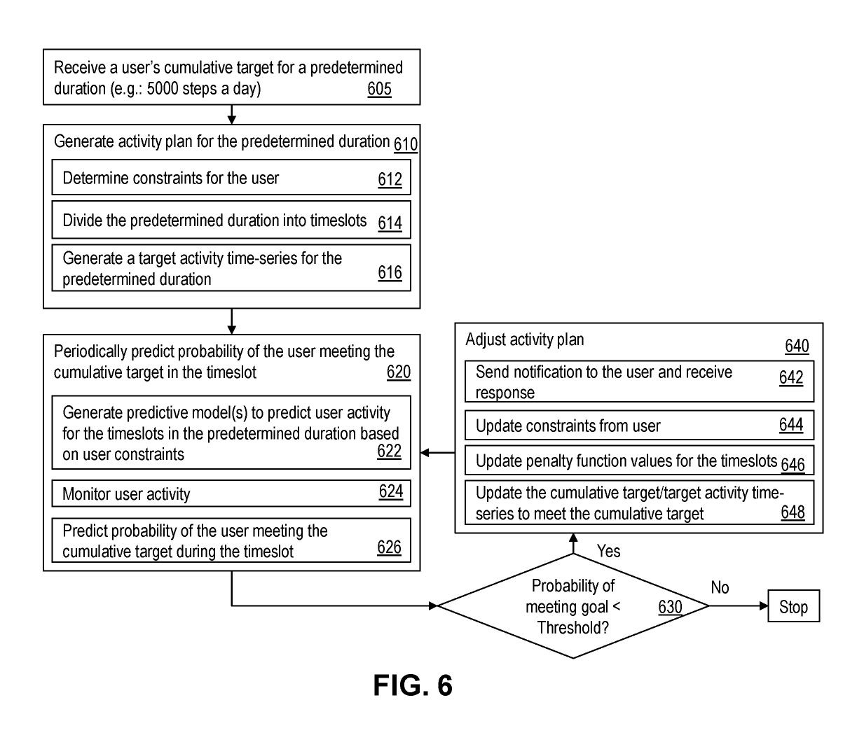

FIG. 6 illustrates a flow-chart of an example method for dynamically tracking and adapting activity targets for a user, according to one or more embodiments of the invention. The method can be implemented by the health management system 100.

The health management system 100 receives a user's cumulative target for a predetermined duration (e.g.: 5000 steps a day), as shown at 605. In one or more examples, the user specifies the cumulative goal via the activity target interface 510. Alternatively, or in addition, the health management system 100 sets the cumulative activity target for the user based on the user's profile.

The health management system 100 further generates an activity plan for the predetermined duration according to the cumulative activity target, as shown at 610. Generating the plan includes the activity planner 520 determining constraints for the user, as shown at 612. For example, the activity planner 520 determines the constraints from the user's calendar, historic activity pattern, and/or user-input. Generating the activity plan further includes dividing the predetermined duration into timeslots, as shown at 614. For example, the activity planner 520 divides a day into 24 hour timeslots. In other examples, the timeslots may be of different durations, such as 120 minutes, 30 minutes, and the like. In one or more examples, the length of the timeslot is configurable by the user.

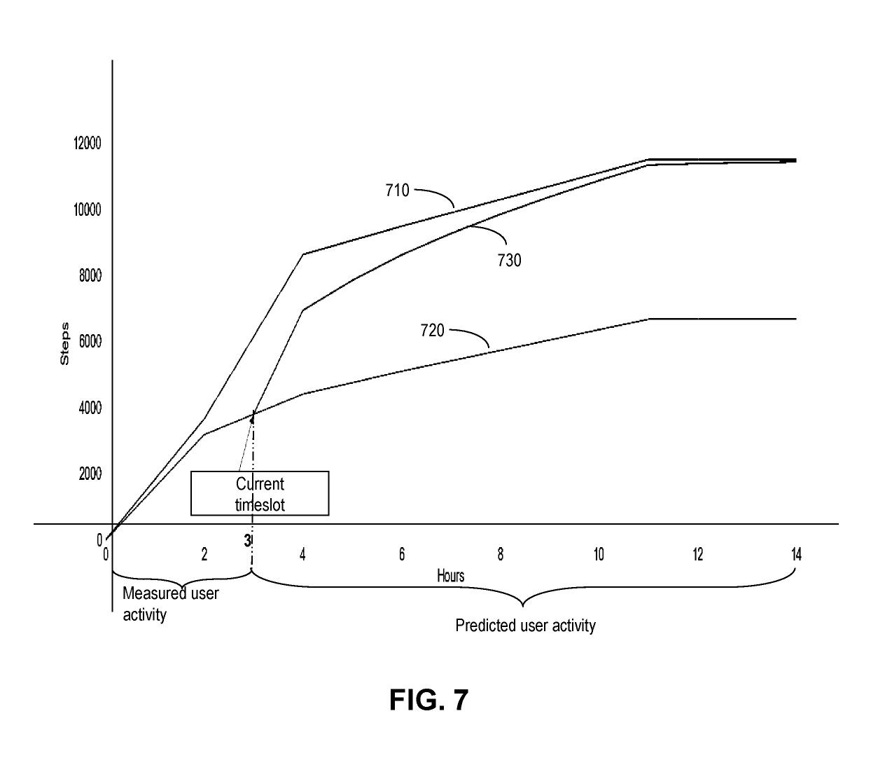

Generating the plan further includes generating a target activity time-series for the predetermined duration, as shown at 616. The target activity time-series includes a series of goals corresponding to each of the timeslots that the predetermined duration is divided into. FIG. 7 illustrates an example target activity time-series 710, according to one or more embodiments of the invention. For example, in the illustrated example, the cumulative target is for 11000 steps in 14 hours (e.g.: 8 AM to 10 PM, 6 AM to 8 PM). In this case, the health management system 100 divides the duration into 14 hour timeslots with step goals for each timeslot as provided by the target activity time-series 710, with about 4000 steps to be taken in the first 2 hours, about 8000 steps to be taken by the first 4 hours, and so on to reach the cumulative goal by the last time slot (14^{th} hour). In this case, the activity planner 520 may determine the activity time-series 710 based on the user's historic performance of more number of steps earlier in the day. Alternatively, or in addition, the activity planner 520 generates the time-series 710 based on the user's input. Further yet, the activity planner 520 displays the time-series to the user, who can interact and edit the activity time-series as s/he desires. It should be noted that the activity time-series 710 is just one example, and that in other examples, the activity time-series can be different than that illustrated.

Referring back to FIG. 6, the health management system 100 periodically predicts probability of the user meeting the cumulative goal based on the target activity time-series 710, as shown at 620. Alternatively, or in addition, the health management system 100 periodically predicts probability of the user meeting the goals in the target activity time-series 710 that is generated.

The prediction includes the activity planner 520 generating predictive model(s) to predict user activity for the timeslots in the predetermined duration based on user constraints, as shown at 622. In one or more examples, the activity planner 520 generates a different predictive model for each timeslot based on the different inputs for each timeslot. Each model predicts user activity for the corresponding timeslot. For example, each model uses the predictions of models for the preceding timeslots as input. Alternatively, the activity planner generates a single predictive model that predicts user activity for each future timeslot in the predetermined duration. In one or more examples, the predictive models are trained using the historical physical activity data (e.g., hour steps from multiple users) and the final cumulative goals (e.g., 5,000 steps) for clustered users. For example, generating a predictive model includes using contextual features (e.g., gender, age, height, weight/BMI, fat percentage, and geographical location) of multiple users and the historical activity data (e.g., hourly steps and weekdays) of the respective users to cluster the users into different groups. For example, the clustering is performed using a clustering algorithm such as k-means, agglomerative nesting hierarchical clustering, and the like. In one or more examples, for each group (cluster) determined by the clustering algorithm, the historical data from all users in the cluster are used as features, and the final goals as the responses to train the predictive models. In one or more examples, if the final goal is changed in the adjusted activity plan, the models are re-trained using the above operations.

In one or more examples, the features that are used from the historical data for training the predictive models include the weekdays and the cumulative steps at each time slot. Further, in one or more examples, the response is a binary variable (for example, yes—if the cumulative goal is met, and no—if not). Further, the predictive models are trained using a machine learning algorithm, such as logistic regression models, SVM, random forests, and the like.

Thus, in one or more examples, the trained predictive models are specific to a cluster, and, for a given cluster, at each timeslot, a predictive model is trained using the final (cumulative) goal and cumulative activity (such as # of steps) at each of the previous timeslots and the current timeslot. For example, if there are 24 timeslots in the predetermined duration, there will be 24 predictive models for a particular cluster. Thus, if there are m clusters and n timeslots, then m*n predictive models in total are trained.

Accordingly, the health management system 100 generates the predictive models for determining the probability of the user meeting the final (cumulative) goal in each step using the cumulative goal and the historical data (the cluster which the user belongs to), the clustering implemented based on the contextual/demographic attributes (gender, age, etc.) of multiple users and historical activity data (e.g., hourly steps) from the multiple users.

The prediction further includes the health management system 100 monitoring user activity at each time-slot and inputting the activity to the predictive models, as shown at 624. In one or more examples, the health management system 100 monitors the activity via the user's device, such as a phone, a wearable device, a pedometer, or any other device. Alternatively, or in addition, the health management system 100 monitors the activity based on the user's input via one or more of the user's devices, for example via a website, a software, and the like.

The trained predictive models are then used to predict the probability of the user meeting the cumulative goal, as shown at 626. Computing such probability includes identifying which cluster the user belongs to, for example based on the demographic information of the user. Next, the final (cumulative) goal provided by the user, the current weekday, and the cumulative steps at each timeslot up to the current one are fed into the predictive model corresponding to the current timeslot in the cluster corresponding to the user. Further, the probability for the user is computed for the current timeslot, which is compared to one or more pre-defined threshold values. In one or more examples, a warning is raised if the probability is below a pre-defined low-range threshold value.

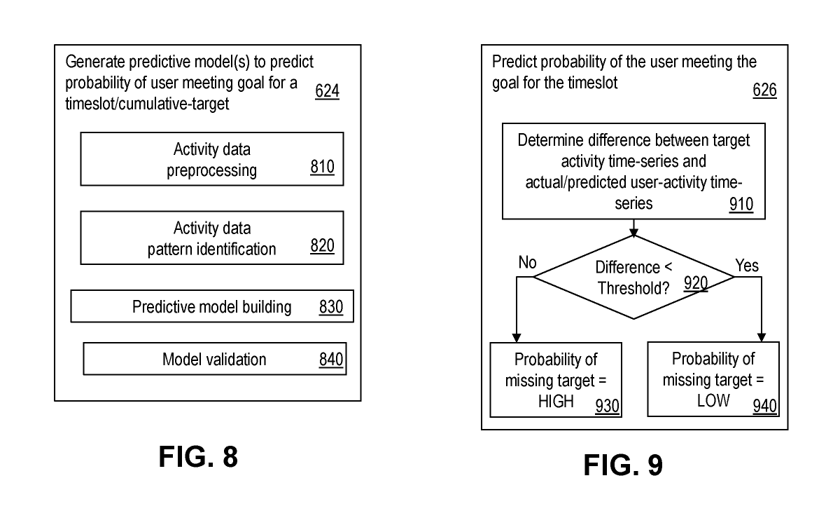

FIG. 8 illustrates a flow chart of an example method for generating a predictive model for predicting a probability of the user meeting a timeslot goal, according to one or more embodiments of the invention. The activity planner initially performs data preprocessing, as shown at 810. The data preprocessing includes, for example cleaning the user activity data. For example, the activity planner 520 can impute missing values in the activity data, in case the health management system 100 has not received user activity data for one or more timeslots. Imputation includes replacing missing data with substituted values, for example based on the user's historic activity data.

Further, the activity planner 520 identifies a pattern from the activity data collected from the user for the predetermined duration until the current timeslot, as shown at 820. For example, the activity planner 520 determines the pattern using an algorithm such as spline fitting and feature generation. Based on the identified pattern, the activity planner 520 builds a predictive model, as shown at 830. In one or more examples, the predictive models are statistical or machine learning models that generate a binary response (yes/no) for the user meeting the final (cumulative) goal during a specific timeslot. For example, the activity planner 520 builds the predictive model using algorithms such as random forest, support vector machine (SVM), logistic regression modeling, and the like or a combination thereof. In one or more examples, the activity planner 520 builds predictive models for each of the future timeslots in the predetermined duration.

For example, referring to the example scenario of FIG. 7, where the target activity time-series is 710, consider that the health management system 100 is in timeslot 3, (i.e. hour 3). For example, if the predetermined duration was the 14 hours from 8 AM to 11 PM, the current timeslot is 11 AM-12 NOON. The activity planner 520, in this snapshot, can access the user activity for timeslots until the current, i.e. 3^{rd} timeslot. The activity planner 520 generates the predictive model using the available data, and predicts the user activity, using the predictive model, for the future timeslots, i.e. hours 3-14. Accordingly, the activity planner 520 generates a user-activity time-series 720, which can include a portion that has measured user-activity and another portion that has predicted user-activity. For example, at the first timeslot, before the predetermined duration starts, the user activity time-series 720 only includes predicted user activity values; while at the final timeslot, at the end of the predetermined duration, the user activity time-series only includes actual measured user activity values.

Referring back to FIG. 6, in one or more examples, the activity planner 520 performs a model validation using test data prior to predicting the user activity, as shown at 840. For example, the trained predictive models are validated using validation data. In one or more examples, a portion of the data such as 80% of the data, is used as the training data for the predictive models, and the rest is used as the validation. In one or more examples, for each cluster, at each timeslot, the predictive model is validated accordingly. Alternatively, or in addition, the physical activity data from new users is stored over multiple days and used dataset to validate the trained predictive models. That is, the system records the ground truth of whether a user reached the final goal or not for the multiple days, along with activity data for those days, and input his/her activity data up to the current timeslot to the trained models to check the outputs. Alternatively, or in addition, the predictive models are validated cross-validation.

Referring back to FIG. 6, based on the predictive model(s), the activity planner 520 determines a probability of the user missing (or meeting) the cumulative target according to the predictive models, as shown at 626. FIG. 9 illustrates a flow chart of an example method for determining a probability of the user missing an activity target, according to one or more embodiments of the invention. For example, the activity planner 520 determines a difference between the target values from the target activity time-series 710 and the user activity time-series 720, as shown at 910. In one or more examples, the difference is a cumulative sum of differences between the values for each timeslot. In one or more examples, the observed activity data from the user until the current timeslot to predict the probability of the user meeting the final (cumulative0 goal is used to determine the difference(s). The activity planner 520 further compares the difference with a predetermined threshold, as shown at 920. If the difference is above (or equal to) the threshold, the activity planner 520 deems that the probability of the user missing the cumulative target is high, as shown at 930, else that the probability is low. It should be noted that, in one or more examples, the activity planner 520 deems that the difference being equal to the threshold denotes a low probability. In one or more examples, the probability value for the user missing the cumulative target is computed as P=Difference/Target, the target being the cumulative target, and the difference being the cumulative sum of the differences across the timeslots.

Referring back to FIG. 6, the activity planner 520 compares the probability of the user missing (or meeting) the cumulative goal with a predetermined threshold, as shown at 630. If the probability of missing the goal is lower than (or equal to) the threshold, the activity planner 520 does not take any action, and continues to iterate the method described herein for the next timeslots in the predetermined duration. if the probability of missing the goal is higher than (or equal to) the threshold, the activity planner 520 adjusts the activity plan, as shown at 640.

In one or more examples, for adjusting the activity plan, the activity planner 520 sends a notification to the user and receives a corresponding response from the user, as shown at 642. For example, the notification generator 540 generates the notification indicating to the user that the progress towards cumulative goal is not being made. The notification may further include a reminder for the activity target for the current timeslot. For example, referring to FIG. 7, if the notification is sent at the timeslot 3, the notification may include a difference between the corresponding values from the target activity time-series 710 and the user-activity time-series 720. The notification may further include the value from the target activity time-series 710. In one or more examples, the notification further includes a question for the user to indicate if the user can meet the target value from the target activity time-series 710 in the current timeslot, with a YES/NO response.

The activity target interface 510 receives the user's response, as shown at 642. The constraint integrator 530 integrates the user response with the constraints for the user, as shown at 644. For example, if the user responds indicating that s/he will not be completing the target, the constraint integrator 530 updates the penalty function value assigned to the timeslot, as shown at 646. Else, if the user responds indicating that the s/he will be completing the target, the constrain integrator 530 maintains the penalty function value for the timeslot, at least until the timeslot completes. After the timeslot has completed, the activity planner updates the penalty function for the timeslot based on the user activity, as shown at 646. If the user does not meet the set goal for the timeslot, the constraint integrator adjusts the penalty function of the timeslot to increase the penalty function for exerting too much effort, and if the goal is met, the penalty function may be maintained or decreased. A high penalty function value during a period is indicative that the user does not prefer or is unable to be active during that period.

Further, the activity planner 520 updates the cumulative target for the user, as shown at 648. For example, for that particular day (duration), the cumulative target can be updated/revised from 5000 steps for the day to 3000 steps for the day, or 10000 steps for the day. Alternatively, or in addition, the health management system 100 generates an updated target activity to meet the new/existing cumulative target. For example, activity planner 520 generates another target activity time-series, such as an updated target activity time-series 730, referring to FIG. 7. In one or more examples, the activity planner 520 takes into account the updated user constraints, and revises the user's cumulative goal. Further yet, in one or more examples, the activity planner 520 the activity planner 520 may change other aspects of the activity, such as to increase/decrease intensity. For example, the activity planner 520, in the updated target activity time-series 730, sets a different pace for the steps, such as jogging, running, etc. Alternatively, or in addition, the updated target activity time-series 730 can include skipping, jumping, and/or other exercises that the activity planner 520 identifies as high-intensity exercises.

In other words, consider a scenario where the target activity time-series 710 includes a first target activity scheduled for completion by a first timeslot in the time-series. Generating the updated target activity time-series 730 for the user includes scheduling a second user-activity to be completed by a second timeslot in response to the user-response indicating completion of the first user-activity by the first timeslot. In one or more examples, the second user-activity may be consistent with the target activity time-series 710. Further, generating the updated target activity time-series 730 includes scheduling a third user-activity to be completed by the second timeslot in response to the user-response indicating failure to complete the first user-activity by the first timeslot. The third user-activity and the second user-activity can be distinct activities that change the intensity level for the user, so as to enable the user to meet the cumulative health-management goal.

It should be noted that in the above example scenarios the activity planner 520 increases the user's intensity level in view of the user falling behind the target activity time-series 710; in one or more examples, the activity planner 520 may decrease the user's intensity level in view of the user exceeding set target activity time-series 710. For example, if the difference between the user-activity time-series 720 and the target activity time-series 710 indicates that the user exceeds the target by at least a predetermined threshold, the activity planner 520 generates the updated target activity time-series 730 that decreases the user's intensity level, and yet meeting the cumulative goal for the predetermined duration. Thus, the health management system 100 improves upon the current static goal planning systems and considers tradeoffs between user's exercise intensity and target.

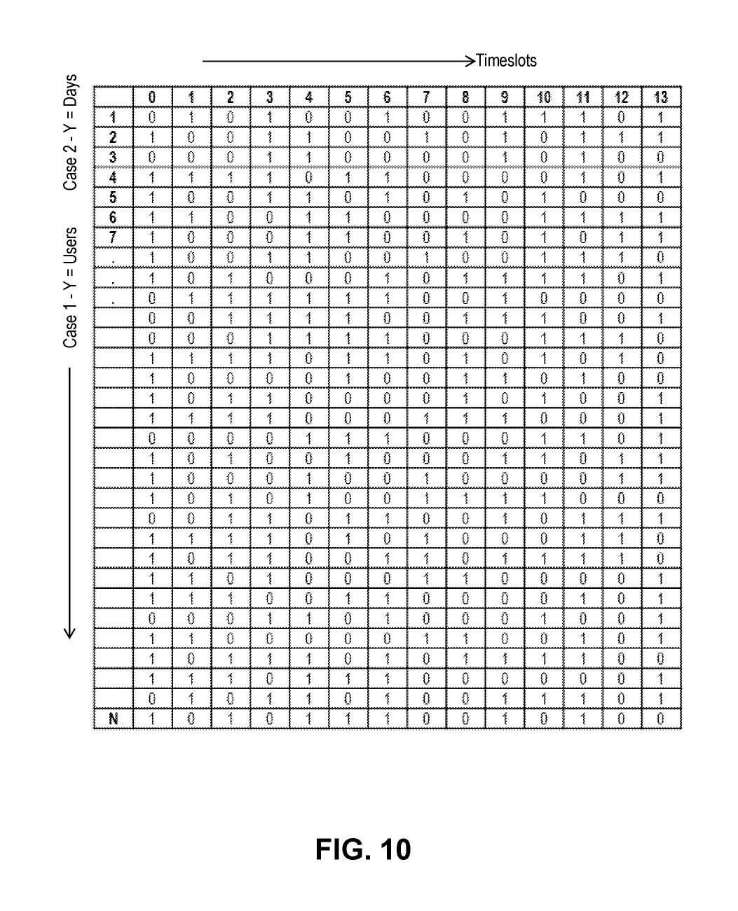

FIG. 10 illustrates example scenarios implemented by the health management system 100 according to one or more embodiments of the invention. For example, for case 1, FIG. 10 illustrates probabilities determined by the health management system 100 for 14 timeslots (X-axis) for multiple users (Y-axis). For example, in this case, each row represents individual users, and each column represents individual timeslots. In the illustration, for each user, the health management system 100 generates a notification for the corresponding user in the timeslots that represent a ‘1’, and does not generate the notification for the timeslots that represent a ‘0’. As described herein, the notifications are generated in the timeslots where the health management system 100 determines that the user cannot meet the activity target.

Further, in case 2, FIG. 10 illustrates probabilities determined by the health management system 100 for the 14 timeslots (X-axis) for a single user across multiple predetermined durations, such as days (Y-axis). For example, un this case, each row represents individual day, and each column represents individual timeslots. In the illustration, for each day, the health management system 100 generates a notification for the user in the timeslots that represent a ‘1’, and does not generate the notification for the timeslots that represent a ‘0’. As described herein, the notifications are generated in the timeslots where the health management system 100 determines that the user cannot meet the activity target.

The technical features herein facilitate the health management system to learn from the user what the user's preferred times for performing the user-activity. Further, the health management system creates an activity plan for the user based on a goal/target that a user may set, or the health management system selects itself. Further, the health management system, in coordination with probability of meeting the goal as a constraint, updates the activity plan in real time based on user activity and predictions of the user activity. The health management system thus facilitates keeping the user on track to meet a goal, and provides timely notification to nudge the user in case the user is falling off the track based on the created activity plan. The technical features include using a predictive model, such as a linear quadratic regulator to predict user activity, based on penalty function values to represent user-constraints. Furthermore, the technical features facilitate using past user behavior to update the penalty function values.

The present technical solutions may be a system, a method, and/or a computer program product at any possible technical detail level of integration. The computer program product may include a computer readable storage medium (or media) having computer readable program instructions thereon for causing a processor to carry out aspects of the present technical solutions.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technical solutions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present technical solutions.

Aspects of the present technical solutions are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Such computer storage media may be part of the device or accessible or connectable thereto. Any application or module herein described may be implemented using computer readable/executable instructions that may be stored or otherwise held by such computer readable media.

The descriptions of the various embodiments of the invention herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for adaptively tracking a health-management goal, the method comprising:
receiving, by a processor, a cumulative target for a predetermined duration for a user;
generating, by the processor, a target activity time-series for the predetermined duration to meet the cumulative target;
receiving, by the processor, a user-activity time-series for the user that indicates activity performed by the user to meet the cumulative target;
monitoring, by the processor, a difference between the target activity time-series and the user-activity time-series;
determining, by the processor, based on the difference, a probability value that indicates the user missing the cumulative target; and
generating, by the processor, an updated target activity time-series for the user in response to the probability value being above a predetermined threshold.

2. The computer implemented method of claim 1, wherein monitoring the difference comprises:
receiving, by the processor, a user-activity performed by the user during a first timeslot from the predetermined duration; and
computing, by the processor, the difference between the user-activity performed during the first timeslot and a target user-activity value for the first timeslot from the target activity time-series.

3. The computer implemented method of claim 2, wherein monitoring the difference further comprises:
predicting, by the processor, user-activity for a second timeslot from the predetermined duration; and
computing, by the processor, the difference between the predicted user-activity for the second timeslot and a target user-activity value for the second timeslot from the target activity time-series.

4. The computer implemented method of claim 3, wherein monitoring the difference further comprises:
computing a sum of the difference computed for each timeslot from a plurality of timeslots from the predetermined duration.

5. The computer implemented method of claim 1, wherein generating the target activity time-series for the predetermined duration to meet the cumulative target comprises:
dividing, by the processor, the predetermined duration into a plurality of timeslots; and
scheduling, by the processor, a first user-activity to be completed by a first timeslot from the predetermined duration.

6. The computer implemented method of claim 5, wherein scheduling the first user-activity comprises determining a penalty function value for the first timeslot based on a user-constraint for the first timeslot.

7. The computer implemented method of claim 6, wherein the user-constraint for the first timeslot is determined based on a user-calendar.

8. The computer implemented method of claim 6, wherein the user-constraint for the first timeslot is determined based on historic data for the user.

9. The computer implemented method of claim 6, wherein generating the updated target activity time-series for the user comprises:
sending, by the processor, a user-notification in response to the probability value being above the predetermined threshold, the user-notification requesting a user-response for a status of user-activity during the first timeslot;
receiving, by the processor, the user-response indicating the status of the user-activity completed by the first timeslot; and
updating, by the processor, the penalty function value for the first timeslot based on the user-response.

10. The computer implemented method of claim 9, wherein the processor increases the penalty function value for the first timeslot in response to the user response indicating that the user-activity by the first timeslot fails to meet the first user-activity scheduled in the target activity time-series.

11. The computer implemented method of claim 9, wherein generating the updated target activity time-series for the user further comprises:
scheduling, by the processor, a second user-activity to be completed by a second timeslot in response to the user-response indicating completion of the first user-activity by the first timeslot; and
scheduling, by the processor, a third user-activity to be completed by the second timeslot in response to the user-response indicating failure to complete the first user-activity by the first timeslot.

12. The computer-implemented method of claim 1, further comprising, generating, by the processor, an updated cumulative target for the user in response to the probability value being above a predetermined threshold.

13. A health management system comprising:
a memory; and
a processor coupled with the memory, the processor configured to:
receive a cumulative target for a predetermined duration for a user;
generate a target activity time-series for the predetermined duration to meet the cumulative target;
receive a user-activity time-series for the user that indicates activity performed by the user to meet the cumulative target;
monitor a difference between the target activity time-series and the user-activity time-series;
determine based on the difference, a probability value that indicates the user missing the cumulative target; and
generate an updated target activity time-series for the user in response to the probability value being above a predetermined threshold.

14. The health management system of claim 13, wherein for monitoring the difference the processor is further configured to:
receive a user-activity performed by the user during a first timeslot from the predetermined duration;
compute a first difference between the user-activity performed during the first timeslot and a target user-activity value for the first timeslot from the target activity time-series;
predict a user-activity for a second timeslot from the predetermined duration; and
compute a second difference between the predicted user-activity for the second timeslot and a target user-activity value for the second timeslot from the target activity time-series; and
compute a sum of the first difference and the second difference.

15. The health management system of claim 13, wherein for generation of the target activity time-series for the predetermined duration to meet the cumulative target the processor is further configured to:
divide the predetermined duration into a plurality of timeslots; and
schedule a first user-activity to be completed by a first timeslot from the predetermined duration, wherein scheduling the first user-activity comprises determining a penalty function value for the first timeslot based on a user-constraint for the first timeslot.

16. The health management system of claim 15, wherein for generating the updated target activity time-series for the user, the processor is further configured to:
send a user-notification in response to the probability value being above the predetermined threshold, the user-notification requesting a user-response for a status of user-activity during the first timeslot;
receive the user-response indicating the status of the user-activity completed by the first timeslot; and
update the penalty function value for the first timeslot based on the user-response.

17. The health management system of claim 16, wherein the processor is further configured to
schedule a second user-activity to be completed by a second timeslot in response to the user-response indicating completion of the first user-activity by the first timeslot; and
schedule a third user-activity to be completed by the second timeslot in response to the user-response indicating failure to complete the first user-activity by the first timeslot.

18. A computer program product for a health goal management, the computer program product comprising a computer readable storage medium having program instructions embodied therewith, the program instructions executable by a processing circuit to cause the processing circuit to:
receive a cumulative target for a predetermined duration for a user;
generate a target activity time-series for the predetermined duration to meet the cumulative target;
receive a user-activity time-series for the user that indicates activity performed by the user to meet the cumulative target;
monitor a difference between the target activity time-series and the user-activity time-series;
determine based on the difference, a probability value that indicates the user missing the cumulative target; and
generate an updated target activity time-series for the user in response to the probability value being above a predetermined threshold.

19. The computer program product of claim 18, wherein for monitoring the difference the executable instruction cause the processing circuit to:
receive a user-activity performed by the user during a first timeslot from the predetermined duration;
compute a first difference between the user-activity performed during the first timeslot and a target user-activity value for the first timeslot from the target activity time-series;
predict a user-activity for a second timeslot from the predetermined duration; and
compute a second difference between the predicted user-activity for the second timeslot and a target user-activity value for the second timeslot from the target activity time-series; and
compute a sum of the first difference and the second difference.

20. The computer program product of claim 18, wherein for generation of the target activity time-series for the predetermined duration to meet the cumulative target the executable instruction cause the processing circuit to:
divide the predetermined duration into a plurality of timeslots; and
schedule a first user-activity to be completed by a first timeslot from the predetermined duration, wherein scheduling the first user-activity comprises determining a penalty function value for the first timeslot based on a user-constraint for the first timeslot.
